(19) United States
(12) Patent Application Publication
(10) Pub. No.: US 2017/0158502 A1
(43) Pub. Date: Jun. 8, 2017

(54) Photochemical Processes and Compositions for Methane Reforming Using Transition Metal Chalcogenide Photocatalysts

(71) Applicant: BOARD OF REGENTS, THE UNIVERSITY OF TEXAS SYSTEM, Austin, TX (US)

(72) Inventors: Russell R. Chianelli, El Paso, TX (US); Brenda Torres, El Paso, TX (US)

(21) Appl. No.: 15/398,976

(22) Filed: Jan. 5, 2017

Related U.S. Application Data
(62) Division of application No. 13/803,416, filed on Mar. 14, 2013.
(60) Provisional application No. 61/610,717, filed on Mar. 14, 2012.

(51) Int. Cl. C01B 3/40; B01J 35/00; B01J 27/045; B01J 27/051; B01J 27/043

(52) U.S. Cl. CPC C01B 3/40; B01J 27/0515; B01J 27/051; B01J 27/043; B01J 27/045; B01J 35/004; C01B 2203/0238; C01B 2203/1064; C01B 2203/107; C01B 2203/1052; C01B 2203/1058; C01B 2203/1241

(57) ABSTRACT

The present invention provides a transition metal chalcogenide photocatalyst, a reactor using the transition metal chalcogenide photocatalyst, and methods of making and using a transition metal chalcogenide photocatalyst for reforming CH₄ with CO₂.

### CONTINUING DATA

The present application is a divisional of and claims priority to U.S. application Ser. No. 13/803,416 filed Mar. 14, 2013, which claims priority to U.S. application Ser. No. 61/610,717 filed Mar. 14, 2012, which are each hereby incorporated by reference in their entirety.

### TECHNICAL FIELD OF THE INVENTION

The present invention relates in general to the field of chalcogenide catalysts and more specifically to compositions of matter and methods of making and using noble metal sulfide photocatalysts for converting CO₂ and CH₄ to useful transportation fuels.

### BACKGROUND OF THE INVENTION

Without limiting the scope of the invention, its background is described in connection with chalcogenide catalysts and gas diffusion electrodes incorporating the same for converting CO₂ and CH₄. Chalcogenide catalysts may be known in the art for other purposes, but the specific compositions of the present invention and the disclosed process of converting CO₂ and CH₄ were unknown until the instant inventors' discovery.

For example, U.S. Pat. No. 6,967,185 entitled, “Synthesis of Noble Metal, Sulphide Catalysts in A Sulfide Ion-Free Aqueous Environment,” discloses a noble metal sulfide catalyst obtained by reaction of a precursor of at least one noble metal with a thionic species in an aqueous environment essentially free of sulfide ions useful as an electrocatalyst in the depolarized electrolysis of hydrochloric acid, the entire contents of which are incorporated herein by reference.

Another example, includes U.S. Pat. No. 6,855,660 entitled, “Rhodium Electrocatalyst and Method of Preparation,” discloses a rhodium sulfide electrocatalyst formed by heating an aqueous solution of rhodium salt until a steady state distribution of isomers is obtained and then sparging hydrogen sulfide into the solution to form the rhodium sulfide and a membrane electrode assembly with the electrode and a process for electrolyzing hydrochloric acid, the entire contents of which are incorporated herein by reference.

For example, U.S. Pat. No. 6,149,782 entitled, “Rhodium Electrocatalyst and Method of Preparation,” discloses a rhodium sulfide catalyst for the reduction of oxygen in industrial electrolyzers. The catalyst is highly resistant towards corrosion and poisoning by organic species, thus resulting particularly suitable for use in aqueous hydrochloric acid electrolysis, when technical grade acid containing organic contaminants is employed, the entire contents of which are incorporated herein by reference.

U.S. Patent Application Publication No. 2004/0242412entitled, “Catalyst for Oxygen Reduction,” discloses ruthenium sulfide catalyst and gas diffusion electrodes incorporating the same for reduction of oxygen in industrial electrolyzers which catalyst is highly resistant to corrosion making it useful for oxygen-depolarized aqueous hydrochloric acid electrolysis, the entire contents of which are incorporated herein by reference.

### BRIEF SUMMARY OF THE INVENTION

The present invention provides a photocatalyst for reforming methane with CO₂ using a transition metal chalcogenide photocatalyst chemically stable in an environment comprising CH₄ and CO₂. The transition metal chalcogenide photocatalyst may include Ti, V, Cr, Mn, Fe, Co, Ni, Zr, Nb, Mo, Tc, Ru, Rh, Pt, Hf, Ta, W, Re, Os, Ir, or Pt or combinations thereof and compositions including TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂, TaS₂, WS₂, ReS₂, OsSₓ, IrSₓ, or PtS₂ or combinations thereof.

The present invention also provides a gas reforming electrode for reforming CH₄ with CO₂. The electrode includes a transition metal chalcogenide photocatalyst applied on at least one face of a conductive web and is chemically stable in an environment comprising CH₄ and CO₂. The conductive web may be a carbon cloth. The catalyst may be mixed with an optionally perfluorinated hydrophobic binder. The transition metal chalcogenide photocatalyst may include Ti, V, Cr, Mn, Fe, Co, Ni, Zr, Nb, Mo, Tc, Ru, Rh, Pt, Hf, Ta, W, Re, Os, Ir, or Pt or combinations thereof and more specific TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂, TaS₂, WS₂, ReS₂, OsSₓ, IrSₓ, or PtS₂ or combinations thereof.

The present invention provides a method for reforming CH₄ with CO₂ by providing a transition metal chalcogenide photocatalyst; contacting the transition metal chalcogenide photocatalyst with a source comprising CH₄ and CO₂; and producing one or more transportation fuels. The transition metal chalcogenide photocatalyst may include Ti, V, Cr, Mn, Fe, Co, Ni, Zr, Nb, Mo, Tc, Ru, Rh, Pt, Hf, Ta, W, Re, Os, Ir, Pt or combinations thereof and more specific TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂TaS₂, WS₂, ReS₂, OsSₓ, IrSₓ, PtS₂ or combinations thereof.

The present invention also provides a rhodium sulfide photocatalyst formed by heating an aqueous solution of a rhodium salt until a steady state distribution of isomers is obtained and then sparging hydrogen sulfide into the solution to form rhodium sulfide.

The present invention provides a photoreactor for reforming methane with CO₂ using a transition metal chalcogenide photocatalyst having a transition metal chalcogenide photocatalyst in the chamber; a source of CH₄ and CO₂ in the chamber in contact with the transition metal chalcogenide photocatalyst; and a source to emit a UV radiation, wherein the transition metal chalcogenide photocatalyst in the presence of the UV radiation converts CH₄ and CO₂ to a hydrocarbon. The transition metal chalcogenide photocatalyst may include TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂, TaS₂, WS₂, ReS₂, OsSₓ, IrSₓ, or PtS₂.

### BRIEF DESCRIPTION OF THE DRAWINGS

For a more complete understanding of the features and advantages of the present invention, reference is now made to the detailed description of the invention along with the accompanying figures and in which:

FIG. 1 is a graph of hydrodesulfurization catalysis by transition metal compositions.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides highly active and selective Transition Metal Chalcogenide catalytic materials as photocatalytic materials. The present invention uses Transition Metal Chalcogenide catalytic materials to photocatalytically perform methane reforming with CO₂. Although methane reforming with CO₂ is a known reaction, it requires very high temperatures in normal catalytic processing. The present invention provides a method of making and using Transition Metal Chalcogenide catalytic materials to photocatalytically perform methane reforming with CO₂ while reducing the energy requirements, and the process could be used remotely to capture energy from petroleum flares that are approximately equal mixtures of CO₂ and CH₄. The present invention provides a UV reactor, and a source of CO₂ and CH₄ in the form of a gas stream (of about 50% 50%) and a RuS₂ catalyst. The process produces clear liquids that have been analyzed to contain paraffins, olefins, and alcohols.

Conventional steam reforming of CO₂ and CH₄ is a very high energy process producing CO and H₂. The present invention provides chalcogenide catalysts and gas diffusion electrodes incorporating the same for converting CO₂ and CH₄. Chalcogenide catalysts may be known in the art for other purposes, but the specific photocatalytic compositions of the present invention and the disclosed process of converting CO₂ and CH₄ were unknown until the instant inventors' discovery. When in the form of a gas diffusion electrode, the chalcogenide catalysts may contact CO₂ and CH₄ and produce long chain alcohols through a photocatalytic process.

In one embodiment, the invention relates to a novel rhodium sulfide catalyst for reduction of CO₂ and CH₄ in an industrial photoreactor. The photocatalyst is highly resistant towards corrosion and poisoning by organic species, thus particularly suitable for use in converting CO₂ and CH₄ into long chain alcohols.

As used herein, the term chalcogenide, Transition Metal Chalcogenide or TMC denotes a chemical compound with at least one chalcogen ion and one more electropositive element. The chalcogen include all group 16 elements of the periodic table. The term more commonly includes sulfides, selenides, and tellurides, and oxides. For example, the metal may include Al, Ag, Au, Pt, Cu, Mg, Cr, Mo, W, Ta, Nb, Li, Mn, Ca, Yb, Ti, Ir, Be, Hf, Eu, Sr, Ba, Cs, Na, K, Pt, Au, Cr, W, Mo, Ta and Nb or alloy thereof. Particularly preferred are Ti, V, Cr, Mn, Fe, Co, Ni, Zr, Nb, Mo, Tc, Ru, Rh, Pt, Hf, Ta, W, Re, Os, Ir, Pt or combinations thereof. As the chalcogenide, includes TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂, TaS₂, WS₂, ReS₂, OsSₓ, IrSₓ, PtS₂ and the like. Examples also include ZnSe, ZnS, TaS, TaSe, ZnO, LiZnSe, LiZnSi, LiZnO and LiInO .

Noble metal sulphides may be used in photocatalysis; in particular, Transition Metal Chalcogenide photocatalysis based on rhodium and ruthenium sulphide. The photocatalyst may be incorporated in gas-diffusion electrode structures for use in the photochemical process for converting CO₂ and CH₄ to useful transportation fuels.

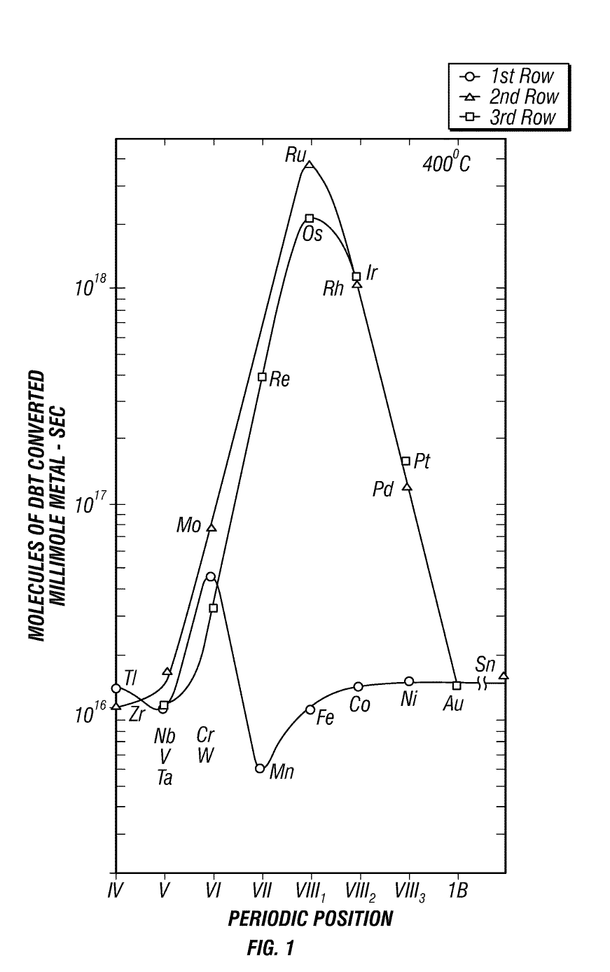

FIG. 1 is a graph of hydrodesulfurization Catalysis by Transition Metals for the compositions in Table 1 below.

TABLE 1

| | | | | | | | |
|---|---|---|---|---|---|---|---|
| 3d | TiS₂ | V₂S₃ | Cr₂S₃ | MnS | FeS | Co₉S₈ | Ni₂S₃ |
| 4d | ZrS₂ | NbS₂ | MoS₂ | TcS₂ | RuS | Rh₂S₃ | PtS |
| 5d | HfS₂ | TaS₂ | WS₂ | ReS₂ | OsS | IrSₓ | PtS₂ |

The synthesis of noble metal sulphide catalysts with hydrogen sulphide in aqueous solutions is conveniently carried out in the presence of a conductive carrier, in most of the cases consisting of carbon particles. In this way, the noble metal sulphide is selectively precipitated on the carbon particle surface, and the resulting product is a carbon-supported catalyst, which is particularly suitable for being incorporated in gas-diffusion electrode structures characterized by high efficiency at reduced noble metal loadings.

A different procedure for the preparation of carbon-supported noble metal sulphide catalysts consists of an incipient wetness impregnation of the carbon carrier with a solution of a noble metal precursor salt, for instance a noble metal chloride, followed by solvent evaporation and gas-phase reaction under diluted hydrogen sulphide at ambient or higher temperature, whereby the sulphide is formed in a stable phase.

Another process for preparing noble metal sulphide catalysts consists of reacting a noble metal precursor with a thio-compound in an aqueous solution free of sulphide ions; in this way, a catalyst is obtained avoiding the use of a highly hazardous and noxious reactant such as hydrogen sulphide.

The present invention provides photocatalytic methane reforming with CO₂ using a Transition Metal Chalcogenide photocatalyst. In one embodiment the present invention provides a RuS₂ Transition Metal Chalcogenide photocatalyst in a UV photoreactor with a source of 50% CH₄ and 50% CO₂ to produce a colorless liquid product of a mixture of paraffins, olefins and alcohols. The reaction products were characterized by an infrared spectroscopy, transmittance data and Nuclear magnetic resonance (NMR) spectroscopy (data not shown).

Under a first aspect, the invention consists of a catalyst for photochemically converting CO₂ and CH₄ to useful transportation fuels using a noble metal sulphide on a conductive carbon. In some embodiments, the noble metal catalyst (Transition Metal Chalcogenide photocatalyst) of the invention may be a single crystalline phase of a binary or ternary rhodium or ruthenium sulphide.

The method of the present invention can be applied to the manufacturing of other single crystalline phases of noble metal sulphides, including not only sulphides of a single metal (binary sulphides) but also of two or more metals (ternary sulphides and so on). The disclosed catalysts are suitable for being incorporated in gas-diffusion electrode structures on electrically conductive webs as known in the art.

For example, rhodium and ruthenium sulphide catalysts are disclosed in the following examples, which shall not be understood as limiting the invention; suitable variations and modifications may be trivially applied by one skilled in the art to manufacture other carbon supported-single crystalline phase sulphide catalysts of different noble and transition metals relying on the method of the invention without departing from the scope thereof.

For example, 100 grams of supported rhodium sulfide were prepared by: 57.3 grams of RhCl₃×H₂O (39.88% given as rhodium metal) were dissolved in 2 liters of de-ionized (D.I.) water, without any pH adjustment. 53.4 grams of active carbon were added, and the mixture was slurried with a magnetic stirrer. Hydrogen sulfide gas was then sparged through the slurry at ambient temperature using nitrogen as a carrier gas. The mixture has been allowed to react as described for 7 hours. Upon completion of the reaction, nitrogen was purged through the system to remove residual H₂S. The remaining solution was vacuum filtered to isolate the solids, which were then washed with de-ionized water and dried at 125° C. to a constant weight. The resulting catalyst cake was finally ground to a fine powder and subjected to 650° C. under flowing argon for two hours. A load of catalyst on carbon of 27-28%, given as rhodium metal, was obtained.

Another example, a final quantity of 6.3 grams of unsupported rhodium sulfide were prepared by the following procedure: 12.1 grams of RhCl₃×H₂O (39.88% given as rhodium metal) were dissolved in 700 ml of de-ionized water, without any pH adjustment. Hydrogen sulfide gas was then sparged through the slurry at ambient temperature using nitrogen as a carrier gas. The mixture was allowed to react as described for 4 hours. Upon completion of the reaction, nitrogen was purged through the system to remove residual H₂S. The remaining solution was vacuum filtered to isolate the solids, which were then washed with de-ionized water and dried at 125° C. to a constant weight. The resulting catalyst cake was ground to a fine powder and subjected to 650° C. under flowing argon for two hours.

An example method to precipitate a rhodium sulphide single crystalline phase on carbon includes precipitation reactions of other noble metal sulphide catalysts (such as the sulphides of ruthenium, platinum, palladium or iridium) only require minor adjustments that can be easily derived by one skilled in the art. 7.62 g of RhCl₃×H₂O were dissolved in 1 liter of de-ionized water, and the solution was refluxed. 7 g of high surface area carbon black were added to the solution, and the mix was sonicated for 1 hour at 40° C. 8.64 g of (NH₄)₂S₂O₃ were diluted in 60 ml of de-ionized water, after which a pH of 7.64 was determined (sulphur source). 4.14 g of NaBH₄were diluted into 60 ml of de-ionized water (reducing agent). The rhodium/carbon solution was kept at room temperature and stirred vigorously while monitoring the pH. In this case, the sulphur source and reducing agent solutions were simultaneously added dropwise to the rhodium/carbon solution. During the addition, pH, temperature and color of the solution were monitored. Constant control of the pH is essential in order to avoid the complete dissociation of the thionic compound to elemental S⁰.

The kinetics of the reaction is very fast, therefore the overall precipitation of the amorphous sulphide occurs within a few minutes from the beginning of the reaction. Cooling the reaction can help in slowing the kinetics if needed. The reaction was monitored by checking the color changes: the initial deep pink/orange color of the rhodium/Vulcan solution changes dramatically to grey/green (reduction of Rh⁺³ to Rh⁺² species) and then colorless upon completion of the reaction, thus indicating a total absorption of the products on carbon. Spot tests were also carried out in this phase at various times with a lead acetate paper; a limited amount of H₂S was observed due to a minimal dissociation of the thionic species. The precipitate was allowed to settle and then filtered; the filtrate was washed with 1000 ml de-ionized water to remove any excess reagent, then a filter cake was collected and air dried at 110° C. overnight. The dried product was finally subjected to heat treatment under flowing argon for 2 hours at 650° C.

The present invention provides a novel photochemical catalyst comprised of a noble metal sulphide (e.g., rhodium sulfide), which may be either supported on a conductive inert carrier or unsupported. This noble metal sulphide does not require any activation step prior to its use, and surprisingly retains its catalytic activity.

In one embodiment, the Transition Metal Chalcogenide photocatalyst may be coated on at least one side of a web, and may be used alone, with a binder, blended with a conductive support and a binder, or supported on a conductive support and combined with a binder. The binder may be hydrophobic or hydrophilic, and the mixture can be coated on one or both sides of the web. The web can be woven or non-woven or made of carbon cloth, carbon paper, or any conductive metal mesh that is resistant to corrosive electrolytic solutions. Examples of high surface area supports include graphite, various forms of carbon and other finely divided supports including carbon black. Such catalyst coated webs can be employed as gas diffusion cathodes. In another embodiment, the Transition Metal Chalcogenide photocatalyst is added to the mixture and not coated or in the form of an electrode.

The ruthenium sulfide catalysts of the present invention may be obtained by a gas-solid reaction: a conductive inert support, preferably high surface area carbon black, is subjected to incipient wetness impregnation with the same. For this purpose, it is useful that the precursor solution contain 2-propanol, or an equivalent, preferably water-miscible, volatile solvent. The precursor solution may be sprayed on the powdery support, or the solution may be slowly added to the support until it can be absorbed. When the incipient wetness impregnation of the support is completed, the resulting impregnated support must be carefully dried, preferably under vacuum at a temperature exceeding 90° C. This operation usually requires a few hours and the resulting dried product is finally subjected to the sulfidation reaction under an atmosphere comprising hydrogen sulfide, preferably in a flow reactor.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. Nos. 6,855,660; 6,149,782; 6,967,185, and 6,149,782

U.S. Publication No. 2004/0242412

1. A method for reforming CH₄ with CO₂ comprising:
(i) contacting a transition metal chalcogenide photocatalyst with a feed source comprising CH₄ and CO₂; and
(ii) irradiating the photocatalyst and feed source with ultraviolet light producing one or more hydrocarbons.

2. The method of claim 1, wherein the transition metal chalcogenide photocatalyst includes Ti, V, Cr, Mn, Fe, Co, Ni, Zr, Nb, Mo, Tc, Ru, Rh, Pt, Hf, Ta, W, Re, Os, Ir, Pt or combinations thereof.

3. The method of claim 1, wherein the transition metal chalcogenide photocatalyst comprises TiS₂, V₂S₃, Cr₂S₃, MnS, FeSₓ, Co₉S₈, Ni₂S₃, ZrS₂, NbS₂, MoS₂, TcS₂, RuS₂, Rh₂S₃, PtS, HfS₂, TaS₂, WS₂, ReS₂, OsSₓ, IrSₓ, PtS₂, Co₉S₈+MoS₂, Co₉S₈+WS₂; Ni₃S₂+MoS₂; Ni₃S₂+WS₂ or combinations thereof.

4. The method of claim 1, wherein the transition metal chalcogenide photocatalyst is a rhodium sulfide or ruthenium sulfide chalcogenide photocatalyst.

5. The method of claim 1, wherein the feed source has a ratio of CH₄ to CO₂ of approximately 1:1.

6. The method of claim 1, wherein the feed source is a petroleum flare.

7. The method of claim 1, wherein the hydrocarbons are paraffins, olefins, alcohols, or a mixture thereof.

8. The method of claim 1, wherein the chalcogenide photocatalyst comprises a transition metal sulphide photocatalyst produced by heating an aqueous solution of a metal salt followed by sparging with hydrogen sulphide, the photocatalyst being chemically stable in an environment comprising CH₄ and CO₂.
